(19) United States
(12) Patent Application Publication
(10) Pub. No.: US 2024/0239633 A1
(43) Pub. Date: Jul. 18, 2024

(54) METHOD FOR ACQUIRING NEW SET OF ELEVATOR OPERATION PARAMETERS OF AN ELEVATOR, AN ELEVATOR SAFETY CONTROL SYSTEM, AND ELEVATOR

(71) Applicant: KONE Corporation, Helsinki (FI)

(72) Inventors: Ari JUSSILA, Helsinki (FI); Toni HIRVONEN, Helsinki (FI); Atso KOSKINEN, Helsinki (FI)

(73) Assignee: KONE Corporation, Helsinki (FI)

(21) Appl. No.: 18/618,083

(22) Filed: Mar. 27, 2024

Related U.S. Application Data
(63) Continuation of application No. PCT/EP2021/081771, filed on Nov. 16, 2021.

(51) Int. Cl. B66B 5/00; B66B 1/34

(52) U.S. Cl. CPC B66B 5/0012; B66B 1/3423; B66B 1/3476; B66B 5/0031

(57) ABSTRACT

A method for acquiring a new set of elevator operation parameters of an elevator includes determining a loss of data integrity relative to a previous set of elevator operation parameters and checking whether a set of pre-conditions for the acquiring are fulfilled, the set of pre-conditions including determining that an elevator car of the elevator is empty of persons, determining that an elevator shaft of the elevator is empty of persons, and determining that a safety system of the elevator is operable. The method also includes initiating a setup run to be performed by utilizing the elevator car for the acquiring of the new set.

### FIELD OF THE INVENTION

The present invention relates in general to elevator systems and other such conveyor systems. In particular, however not exclusively, the present invention concerns setup runs of elevators.

### BACKGROUND

During commissioning, an elevator may perform a setup run to acquire and memorize parameter data of operation parameters needed for the operation of the elevator control system. This data may comprise elevator shaft parameters, including floor positions and door sides.

The acquired data may be used for several purposes, such as for controlling the movement of the elevator car, for absolute positioning system of the elevator car, and/or for traction/rope slipping monitoring of an elevator, for example. Therefore, the accuracy of the data is important.

In case the data of the operation parameters are lost for one reason or another, a service technician is required to go to the elevator site and manually initiate the setup run. This is laborious and can cause severe and unplanned downtime for the elevator.

### SUMMARY

An objective of the present invention is to provide a method for acquiring a new set of elevator operation parameters of an elevator, an elevator safety control system, and an elevator. Another objective of the present invention is that the method, the elevator safety control system, and the elevator at least provide further information concerning the abnormal condition of the elevator, or even that the normal operation is restored without the need to visit the elevator site physically.

The objectives of the invention are reached by a method for acquiring a new set of elevator operation parameters of an elevator, an elevator safety control system, and an elevator as defined by the respective independent claims.

According to a first aspect, a method for acquiring a new set of elevator operation parameters of an elevator is provided, wherein the new set includes at least one elevator operation parameter. The method comprises:
determining a loss of data integrity, for example by utilizing a checksum algorithm, relative to a previous set of elevator operation parameters,
checking whether a set of pre-conditions for the acquiring are fulfilled, wherein the set of pre-conditions comprises at least:
   determining that a movable unit or an elevator car of the elevator is empty of persons,
   determining that an elevator shaft of the elevator is empty of persons, and
   determining that a safety system of the elevator is operable, and
initiating a setup run to be performed by utilizing the elevator car for the acquiring of the new set.

The initiating may, preferably, comprise at least generating a request, such as a control signal, for performing the setup run within the elevator. The setup run may then be performed by an elevator drive system as a response to the request.

The previous set refers to the set of operation parameters which was in place/running/utilized but which data integrity was then determined to be lost. Thus, the previous setup could also be referred to as the current setup which data integrity has been determined to be lost since that set, even if corrupted, is still “in place”. Nevertheless, there has been a valid set of operation parameters in the elevator and previous or current set refers to that set which data integrity is then determined to be lost.

The method may further comprise, after the initiation and during the setup run, obtaining data, preferably by an absolute positioning system of the elevator, related to the elevator operation parameters or based on which the elevator operation parameters are obtainable, and storing the data into a memory. In addition, the method may comprise determining the new set of elevator operation parameters upon successful completion of the setup run. Further, in addition, the method may comprise initiating a normal operation of the elevator by utilizing the new set of elevator operation parameters.

The set of pre-conditions may further comprise determining that the loss of data integrity occurred during normal operation of the elevator.

Alternatively or in addition, the set of pre-conditions may further comprise determining that the elevator is fault-free relative to the performing of the setup run.

In various embodiments, the initiation of the setup run may be performed automatically in response to the determining the loss of data integrity if the set of pre-conditions are fulfilled.

Alternatively, the initiation of the setup run may be enabled to be performed remotely, for example, from a remote service or control center, in response to the determining the loss of data integrity if the set of pre-conditions are fulfilled.

In various embodiments, whether being run automatically or remotely, the method may comprise simulating the initiation of the setup run, wherein the simulating comprises at least changing a status of a manual switch in an elevator control system remotely.

The method may comprise monitoring the data integrity. Thus, the determining the loss of data integrity may occur during the monitoring.

In various embodiments, the loss of data integrity may be determined in response to detecting at least one selected from the group consisting of: data corruption, data incompatibility, a change in the at least one elevator operation parameter, a change of an operating software version, a faulty magnet in a safety and/or control system, or an absolute positioning system of an elevator car has been corrupted or is incompatible, e.g. after an installation error of the absolute positioning system.

The set of elevator operation parameters may relate to operation parameters of an elevator shaft.

In various embodiments, the setup run is an elevator set up run or an elevator door system setup run.

According to a second aspect, an elevator safety control system comprising a processing unit and a memory unit is provided. The elevator control system is configured to execute a method in accordance with the first aspect. Thus, the elevator control system is configured to: determine a loss of data integrity relative to a previous set of elevator operation parameters, and check whether a set of pre-conditions for the acquiring are fulfilled, the set of pre-conditions comprising: determine that a movable unit or an elevator car of the elevator is empty of persons, determine that an elevator shaft of the elevator is empty of persons, and determine that a safety system of the elevator is operable. Furthermore, the elevator control system is configured to initiate, such as including at least generating a request for, a setup run to be performed by utilizing the movable unit or the elevator car for the acquiring of the new set.

According to a third aspect. an elevator or elevator system is provided. The elevator comprises at least one elevator car, or other movable unit, movable in an elevator shaft, an elevator drive system for moving the movable unit or the elevator car, and an elevator safety control system in accordance with the second aspect, wherein the elevator drive system is configured for performing the setup run based on the initiation thereof. The elevator drive system may comprise, for example, an elevator motor and in connection thereto a motor control unit.

The present invention provides a method for acquiring a new set of elevator operation parameters of an elevator, an elevator safety control system, and an elevator. The present invention provides advantages over known solutions no immediate site visit required due to lost of operation parameters, or the “setup”, of the elevator. Thus, restoring the data may be performed without unnecessary delays and without visit of service personnel to the elevator site. Even if the setup run, whether automatic or remotely initiated, fails, it can provide additional information, which can be used when planning the site visit. For example, information can be collected about required spare parts, which means that the amount of site visits is minimized. Furthermore, the elevator can possibly be returned to normal operation automatically or remotely and call out is avoided, thereby the elevator out of use time can at least be shortened, if not almost completely avoided except for the time taken by the setup run, and elevator is taken back to normal operation faster.

The solution is described herein is mainly presented in connection with restoration of elevator shaft setup data; however it is to be understood that it is well suitable for restoration of other elevator parameters data as well, such as for restoration of elevator door parameter data, elevator door operator parameter data, elevator brake controller parameter data and/or elevator drive parameter data (e.g. restoration of control parameters of elevator speed control loop or control parameters of elevator torque control loop).

Various other advantages will become clear to a skilled person based on the following detailed description.

The expression “a plurality of” may refer to any positive integer starting from two (2), that is being two/at least two, or more, such as three/at least three, four/at least four, and so on.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 shows a flow diagram of a method in accordance with an embodiment.

FIG. 2 illustrates schematically an elevator safety control system in accordance with an embodiment.

FIG. 3 illustrates schematically an elevator in accordance with an embodiment.

### DETAILED DESCRIPTION OF SOME EMBODIMENTS

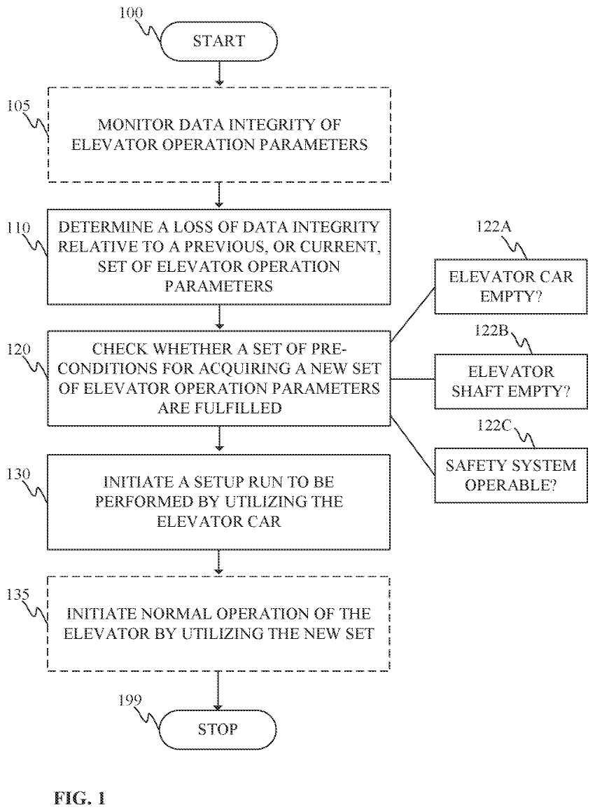

FIG. 1 shows a flow diagram of a method in accordance with an embodiment. Item 100 refers to a start-up phase of the method. Suitable equipment and components are obtained, and (sub-)systems assembled and configured for operation.

The “items” in connection with FIG. 1 may be method steps or features of a controlling unit and/or the elevator (system) itself, for instance. For example, item 100 may include a method step relating to the arrangement of at least necessary systems and components.

Of course, the method may be implemented in an already operable elevator, thereby making item 100 an optional feature. Alternatively or in addition, item 100 may refer to the controlling unit and/or the elevator (system) that may be configured to operate in the some, such as the normal, manner. This applies also to other items described in FIG. 1.

In some embodiments, the method may, optionally, comprise monitoring 105 data integrity related to operation parameters of the elevator. This may be implemented by checksum algorithm, for instance. Set of operation parameters data may thus be protected, for example, with a 32- or 16-bit CRC (cyclic redundancy check) checksum. Whenever the data is written into the memory, it is verified that it is written correctly and when it is read it is verified that the calculated checksum matches to the stored checksum, thereby being able to verify the data integrity. Other known methods for determining the integrity may alternatively be used. In some embodiments, the elevator may comprise a dedicated circuit for monitoring and/or testing the data integrity.

For example, a programmable random access memory testing circuit may be used which detects a signal to initiate testing of at least one random access memory circuit having regard to the data integrity. The testing circuit reads application data in a first memory block of the at least one memory circuit to a temporary memory of the testing circuit. The testing circuit executes marching test for the first memory block in a memory circuit. Then the testing circuit returns the application data back to the first memory block in the memory circuit.

Item 110 refers to determining a loss of data integrity relative to a previous set of elevator operation parameters. The loss of data integrity may, optionally, be determined during the monitoring 105 of the data integrity or the indication of the loss may be provided essentially from outside the elevator, or at least outside the elevator safety control system of the elevator. The set of elevator operation parameters may relate to, for example, operation parameters of an elevator shaft, such as certain locations therein which may be related to landing floors and/doors. One example of an elevator operation parameter may be or relate to a door zone in the elevator shaft.

For example, the loss of data integrity may be determined in response to detecting at least one selected from the group consisting of: data corruption, such as based on detecting an error by a checksum algorithm, data incompatibility, a change in the at least one elevator operation parameter, a change of an operating software version, a faulty magnet in a safety and/or control system. One example related to faulty magnets or other components is that an unknown magnet is detected (faulty magnet replaced by service personnel, for instance, and no new setup run has then been performed). In some elevators, it may be the case that there is a mismatch between information related to a detected floor type and corresponding magnet type. Furthermore, an absolute positioning system of an elevator car may have been corrupted or is incompatible, e.g. after an installation error of the absolute positioning system.

Item 120 refers to checking whether a set of pre-conditions for the acquiring are fulfilled, the set of pre-conditions comprising: determining that an elevator car of the elevator is empty of persons (item 122A), determining that an elevator shaft of the elevator is empty of persons (item 122B), and determining that a safety system of the elevator is operable (122C), e.g., there are no critical faults.

For example, the determination of the empty elevator car may be performed by a load weighing device that indicates that there are no passengers (that is, it measures no mass or mass under some weight threshold value) in the car. In addition or alternatively, an optical sensor, such as a camera or a closed-circuit television (CCTV), may be arranged into the elevator car for determining that the car is empty. The measurement of the optical sensor may be processed by a processing unit, such as by a pattern recognition algorithm thereon.

For example, the determining that an elevator shaft of the elevator is empty of persons may be performed by verifying that a service technician is not on the site of the elevator. This may be done based on, for example, checking whether a service technician has utilized his/her authorization badge or the like at the site of the elevator. Furthermore, empty shaft may be determined by an optical sensor, such as by a camera in the shaft (CCTV). Furthermore, this may also be relevant if there are temporary safety/services spaces arranged to the elevator shaft. Thus, it may be determined that the temporary spaces are dismantled/taken away and that the persons have exit the shaft, if any.

For example, the determining that a safety system of the elevator is operable may mean determining that determining that a static safety chain of the elevator is closed, that is, it does not indicate any further operational anomaly.

Item 130 refers to initiating, such as including at least generating a request for, a setup run to be performed by utilizing the elevator car for the acquiring of the new set. The setup run may then be performed as a response to the initiating, and/or the request, by the elevator drive system. The setup run may be an elevator setup run or an elevator door system setup run, for instance.

Method execution may be stopped at item 199. Thus, the setup run has at least been initiated, for example, automatically or remotely, and optionally also finished successfully or unsuccessfully.

In various embodiments, the method may comprise determining whether local regulations, such as legal regulations, allow the setup run to be performed automatically. This may be done already when setting up the elevator or when the loss of data integrity is detected, or as a part of checking the pre-conditions (that is, the local regulations being one of the pre-conditions). In some cases, the local regulations may prevent the automatic setup run. If this is the case, the method may comprise determining whether local regulations, such as legal regulations, allow the setup run to be performed remotely.

In an embodiment, the method may comprise, after the initiation and during the subsequent setup run, obtaining data, preferably by an absolute positioning system of the elevator, related to the elevator operation parameters or based on which the elevator operation parameters are obtainable, and storing the data into a memory. In this case too, the setup run has at least been initiated, for example, automatically or remotely, and at least to some extent, even slightly, the movable unit of the setup run, such as the elevator car or door or motor or (traction) sheave or the like, has also been moved, that is it has changed its position. Furthermore, in this case too, the setup run may be finished successfully or unsuccessfully.

The method may comprise determining the new set of elevator operation parameters upon successful completion of the setup run. Thus, if it is verified that the setup run has been completed successfully, the new set of operation parameters have been acquired. The verification may be based on monitoring the elevator during the setup run, such as relative to one or many parameters, sequences, etc. of the setup run. As the skilled person can contemplate, the setup run is pre-defined sequence of steps/events which are executed. Thus, verifying that all sequences have been properly performed during the setup run may, preferably, be part of the overall process of setup run.

In various embodiments, the method may further comprise initiating the normal operation of the elevator by utilizing the new set of elevator operation parameters. This may be identical or different to the process when the elevator is begun to be used for the first time after determination of the operation parameters, such as after an initial setup run or other way of determining and loading the operation parameters, whatever may be the case.

Regarding the set of pre-conditions, they may further comprise determining that the loss of data integrity occurred during the normal operation of the elevator. Thus, if the loss of data integrity occurs during abnormal conditions, such as when service personnel has set the elevator to maintenance mode, the setup run may not be initiated. Furthermore, the check for the loss of data integrity during the normal operation may, preferably, also include verification that the previous set, which data integrity was lost, actually existed. Thus, there has been a valid set of operation parameters in the elevator. In addition, there may be determined a time period for having no set of operation parameters or invalid set, which time period, if exceeded, can also be one pre-condition for the setup run.

Alternatively or in addition, the set of pre-conditions may further comprise determining that the elevator is fault-free relative to the performing of the setup run. If the elevator safety control system includes any flags or information related to detected faults, the setup run may not be initiated.

A further pre-condition may be that it is checked if an automatic setup run has been attempted already after the loss of data integrity (or an attempt counter has reached a given threshold). If there has been previous attempt, or too many of them, it may be concluded that automatic setup run is not to be initiated any more.

Regarding the initiation of the setup run, the initiation of the setup run may be performed automatically in response to the determining the loss of data integrity if the set of pre-conditions are fulfilled. Alternatively, the initiation of the setup run may be enabled to be performed remotely in response to the determining the loss of data integrity if the set of pre-conditions are fulfilled.

In various embodiments, whether to initiation of the setup run is done automatically or remotely, and/or notwithstanding what is the combination of abovementioned pre-conditions, the method may comprise simulating the initiation of the setup run, wherein the simulating comprises at least changing a status of a manual switch in an elevator control system remotely.

A non-limiting example of the simulation is as follows: the elevator comprises a manual switch, such as a safety switch, which must be manually operated by a service personnel to initiated the setup run. These kinds of switches may be located, for example, in a manual operating interface of an elevator control cabinet, which cabinet is disposed, e.g. on a landing floor or in a machine room, outside of elevator shaft. Thus, “simulating” means here that said switch(es) is/are not, in fact, operated manually at all at the site of the elevator but changing of the status of said switch(es) is executed by, for example, a computer program instead, either remotely or automatically. This may entail that the manual switch(es) keep(s) its/their physical status or state but the status is changed only in a programmable manner.

In some embodiments, the safety switch may be, for example, an RDF (rescue drive function) switch. RDF operation refers to an elevator operating mode wherein one or more of the safety circuits of the elevator are bypassed, in this case by the RDF switch, which the RDF switch is set to an inspection position. RDF switch is merely a one example of the safety switch in relation to the simulating as referred to herein. There may be, depending on the elevator, one or several other switches or devices which are to be operated, conventionally by the service personnel at the site of the elevator, in order to perform the setup run. In various embodiments, all necessary switches and devices are either configured to automatically change their statuses/states or the statuses/states are being changed remotely, if the pre-conditions are met so that the setup run can be performed without the need to send service personnel to the elevator site.

Thus, after the initiation 130, such as the request or the control signal preferably included therein, and successful performing of the setup run, the method may, optionally, comprise initiating 135 a normal operation of the elevator by utilizing the new set of elevator operation parameters.

Some examples of the use cases of at least some embodiments of the present invention are explained in the following. The set of operation parameters is lost due corruption of stored data, for example, when non-volatile memory write operation is interrupted by a power break or outage. Non-volatile memory is still functional but because the setup data has been lost, a new setup run is required. Normal operation of the elevator may then be restored automatically after the successful setup run.

Another example is that the set of operation parameters are lost due to a magnet being improperly aligned. The pre-conditions for the setup run are checked and, if possible, the setup run initiated. If the fault is still detected during the setup run when the improperly set magnet is reached or passed, the setup run may be configured such that the elevator car stops next to the failed magnet. Thus, even if the setup run is not successful due to the persisting fault due to said magnet, and service technician knows, which magnet must be replaced, since the elevator car has stopped at said magnet. This way more information can be obtained of the fault even if the setup run itself was not successful.

Still a further example relates to updating of control software which may be set to require a new setup run. Conventionally this has meant that a service person needs to be on site of the elevator. If, however, the setup run is initiated remotely in accordance with an embodiment, the site visit by the service person may not be required at all.

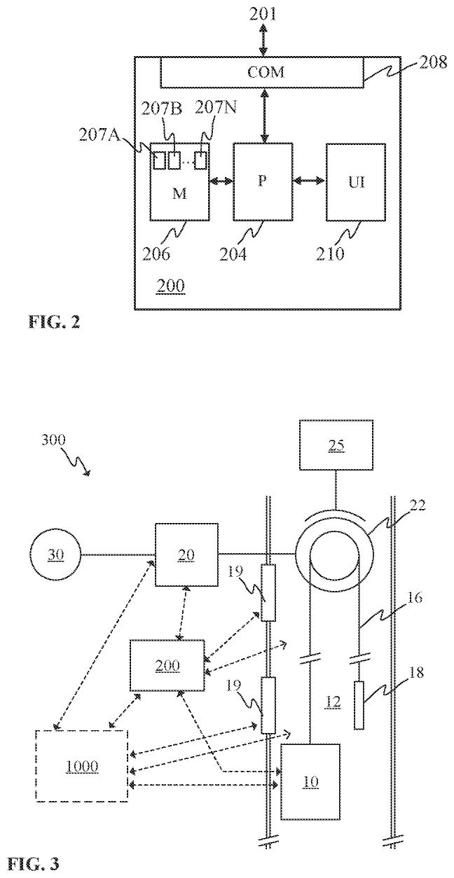

FIG. 2 illustrates schematically an elevator safety control system 200 according to an embodiment of the present invention. External units 201 may be connected to a communication interface 208 of the elevator safety control system 200. The external unit 201 may comprise wireless connection or a connection by a wired manner. The communication interface 208 provides interface for communication with external units 201, such as for receiving elevator operation parameter related data during setup run. There may also be connecting to the external system, such as a laptop or a handheld device. There may also be a connection to a database of the elevator or an external database including information used in controlling the operation of the elevator.

The elevator safety control system 200 may comprise one or more processors 204, one or more memories 206 being volatile or non-volatile for storing portions of computer program code 207A-207N and any data values and possibly one or more user interface units 210. The mentioned elements may be communicatively coupled to each other with e.g. an internal bus.

The processor 204 of the elevator safety control system 200 is at least configured to implement at least some items or method steps as illustrated in and/or described in connection with FIG. 1 hereinabove. The implementation of the method may be achieved by arranging the processor 204 to execute at least some portion of computer program code 207A-207N stored in the memory 206 causing the processor 204, and thus the elevator safety control system 200, to implement one or more items and/or method steps as described. The processor 204 is thus arranged to access the memory 206 and retrieve and store any information therefrom and thereto. For sake of clarity, the processor 204 herein refers to any unit suitable for processing information and control the operation of the elevator safety control system 200, among other tasks. The operations may also be implemented with a microcontroller solution with embedded software. Similarly, the memory 206 is not limited to a certain type of memory only, but any memory type suitable for storing the described pieces of information may be applied in the context of the present invention.

As indicated in FIG. 2, the elevator safety control system 200 may indeed be a single device having necessary functionalities being implemented therein and able to communicate with, such as receive data from and transmit data to, other entities. The elevator safety control system 200 may indeed be arranged to communicate between one or several entities of the elevator and even outside the elevator, such as over the internet with remote service or control center. However, the elevator safety control system 200 may alternatively be implemented as a distributed system, such as having a plurality of devices, at least some of them being in communication with each other. Thus, the elevator safety control system 200 is not necessarily situated in one location of the elevator but may be physically distributed functional entity.

FIG. 3 illustrates schematically an elevator 300, or an elevator or conveyor system, in accordance with an embodiment. The elevator 300 comprises at least one elevator car 10, or other movable unit, movable in an elevator shaft 12. The elevator 300 also preferably comprises the elevator safety control system 200.

The elevator 300 may preferably comprise an electric motor 20 for moving an elevator car 10 comprised in the elevator 300. The elevator car 10 may be mechanically coupled to the electric motor 20, for example, by a hoisting rope 16, hydraulic means or in more direct manner in case of a linear motor. The operation of the electric motor 20 may be controlled by a motor control unit (not shown) such as a frequency converter or an inverter.

The hoisting rope 16 may comprise, for example, steel or carbon fibers. The term ‘hoisting rope’ does not limit the form of the element anyhow. For example, the hoisting rope 16 may be implemented as a rope, a belt, or a track in ropeless or rope-free elevators.

The elevator 300 may comprise an elevator control unit 1000 for controlling the operation of the elevator 1000. The elevator control unit 1000 may be a separate device or may be comprised in the other components of the elevator 1000 such as in or as a part of the electrical drive (not shown). The elevator control unit 1000 may also be implemented in a distributed manner so that, e.g., one portion of the elevator control unit 1000 may be comprised in the electrical drive (not shown) and another portion in the elevator car 10, for instance. The elevator control unit 1000 may also be arranged in distributed manner at more than two locations or in more than two devices.

In some embodiments, the elevator safety control system 200 may be essentially part of the elevator control unit 1000. However, in some other embodiments, they are separate systems, however, preferably in communication connection with one another.

The safety control system 200 may be configured, when initiating the setup run, to generate a request for the setup run to be performed by utilizing the elevator car 10 for the acquiring of the new set of elevator operation parameters, in response to the determining the loss of data integrity and if the set of pre-conditions are fulfilled. The elevator drive system may be configured for performing the setup run based on the request.

The elevator 300 may comprise an elevator brake arrangement 25 comprising an elevator brake, preferably, an electromechanical elevator brake.

Other elements shown in FIG. 1, which may or may not be utilized in embodiments of the present invention, are a main electrical power supply 30 such as a three- or single-phase electrical power grid for powering different devices of the elevator 300. For example, the electrical drive (not shown) and the electric motor 20. The elevator car 10 may operate in the elevator shaft 12 or hoistway 12 serving landing floors 19. There may or may not be a counterweight 18 utilized in an embodiment of the present invention. The hoisting rope 16 may be arranged in connection with a traction sheave 22.

Regarding the normal operation of the elevator 300, the normal operation refers herein to the mode of operation where there are no critical faults existing in the system and the elevator car 10 can serve the landing floors based on a pre-defined control logic and incoming elevator call signals. Critical faults are faults which directly affect the safety of the elevator 300 which, thus, cause the elevator safety control system 200 to prevent the use of elevator car 10 by others than certified service personnel. An example of a non-critical fault is a faulty light which is not related to safety or emergency situations, for instance.

Lists and groups of examples provided in the description given above are not exhaustive unless otherwise explicitly stated.

1. A method for acquiring a new set of elevator operation parameters of an elevator, the new set including at least one elevator operation parameter, the method comprising:
determining a loss of data integrity relative to a previous set of elevator operation parameters;
checking whether a set of pre-conditions for the acquiring are fulfilled, the set of pre-conditions comprising:
determining that an elevator car of the elevator is empty of persons, persons;
determining that an elevator shaft of the elevator is empty of persons, persons; and
determining that a safety system of the elevator is operable; and
initiating a setup run to be performed by utilizing the elevator car for the acquiring of the new set.

2. The method of claim 1, further comprising, after the initiation and during the setup run, obtaining data related to the elevator operation parameters or based on which the elevator operation parameters are obtainable, and storing the data into a memory.

3. The method of claim 2, further comprising determining the new set of elevator operation parameters upon successful completion of the setup run.

4. The method of claim 3, further comprising initiating a normal operation of the elevator by utilizing the new set of elevator operation parameters.

5. The method of claim 1, wherein the set of pre-conditions further comprises determining that the loss of data integrity occurred during normal operation of the elevator.

6. The method of claim 1, wherein the set of pre-conditions further comprises determining that the elevator is fault-free relative to the performing of the setup run.

7. The method of claim 1, wherein the initiation of the setup run is performed automatically in response to the determining the loss of data integrity if the set of pre-conditions are fulfilled.

8. The method of claim 1, wherein the initiation of the setup run is enabled to be performed remotely in response to the determining the loss of data integrity if the set of pre-conditions are fulfilled.

9. The method of claim 7, further comprising simulating the initiation of the setup run, wherein the simulating comprises at least changing a status of a manual switch in an elevator control system remotely.

10. The method of claim 1, further comprising monitoring the data integrity.

11. The method of claim 1, wherein the loss of data integrity is determined in response to detecting at least one selected from the group consisting of: data corruption, data incompatibility, a change in the at least one elevator operation parameter, a change of an operating software version, a faulty magnet in a safety and/or control system, or an absolute positioning system of an elevator car has been corrupted or is incompatible.

12. The method of claim 1, wherein the set of elevator operation parameters relates to operation parameters of an elevator shaft.

13. The method of claim 1, wherein the setup run is an elevator setup run or an elevator door system setup run.

14. An elevator safety control system comprising a processing unit and a memory unit, the elevator control system configured to:
determine a loss of data integrity relative to a previous set of elevator operation parameters;
check whether a set of pre-conditions for the acquiring are fulfilled, the set of pre-conditions comprising:
determining that an elevator car of the elevator is empty of persons, persons;
determining that an elevator shaft of the elevator is empty of persons; and
determining that a safety system of the elevator is operable; and
initiate a setup run to be performed by utilizing the elevator car for the acquiring of the new set.

15. An elevator comprising:
at least one elevator car movable in an elevator shaft;
an elevator drive system for moving the elevator car; and
the elevator safety control system of claim 14,
wherein the elevator drive system is configured for performing the setup run based on the initiation thereof.

16. The method of claim 1, further comprising, after the initiation and during the setup run, obtaining data by an absolute positioning system of the elevator, the data being related to the elevator operation parameters or based on which the elevator operation parameters are obtainable, and storing the data into a memory.

17. The method of claim 2, wherein the set of pre-conditions further comprises determining that the loss of data integrity occurred during normal operation of the elevator.

18. The method of claim 3, wherein the set of pre-conditions further comprises determining that the loss of data integrity occurred during normal operation of the elevator.

19. The method of claim 4, wherein the set of pre-conditions further comprises determining that the loss of data integrity occurred during normal operation of the elevator.

19. The method of claim 2, wherein the set of pre-conditions further comprises determining that the elevator is fault-free relative to the performing of the setup run.
